(19) United States
(12) Patent Application Publication
(10) Pub. No.: US 2009/0119163 A1
(43) Pub. Date: May 7, 2009

(54) Methods for advertising in electronic media

(76) Inventors: Michael B. McMahon, Atlanta, GA (US); Donald F. Willis, JR., Atlanta, GA (US); Daniel J. Gonzalez, Decatur, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/901,390

(22) Filed: Sep. 17, 2007

Related U.S. Application Data
(60) Provisional application No. 60/845,474, filed on Sep. 18, 2006.

(51) Int. Cl. G06Q 30/00

(52) U.S. Cl. 705/14

(57) ABSTRACT

Embodiments of the invention seek to overcome one or more of the disadvantages described above by leveraging electronic advertisements that were developed for use in one distribution channel in another distribution channel. In addition, embodiments of the invention better integrate an electronic advertisements into electronic content. Embodiments of the invention also provide alternative methods for valuing electronic advertisements that may be better suited to present and emerging distribution channels.

This application claims priority to and the benefit of the filing date of U.S. Provisional Patent Application No. 60/845,474, filed Sep. 18, 2006, which is herein incorporated by reference in its entirety.

### TECHNICAL FIELD

This disclosure relates generally to data processing systems and methods, and more particularly, but without limitation, to systems and methods related to advertising in electronic media.

### BACKGROUND

Electronic advertisements are typically delivered over the same communication channels that deliver electronic media content. For example, broadcast or on-demand video stream content delivered over a broadband link may include periodic advertisements within the media content in similar fashion to conventional broadcast television (TV). Furthermore, Web-based content may be displayed together with banner advertisements or hyperlinks to an advertiser's Web page or promotional message.

Known systems and methods for advertising in electronic media have many disadvantages, however. For instance, the diversity of electronic media formats has increased costs associated with developing and distributing electronic advertisements. For example, an advertisement agency might develop a TV advertisement separately from a Web-based advertisement.

Another disadvantage is that advertisements that are associated with electronic content may be perceived by the intended audience as intrusive and/or undesirable. Thus, a Web page recipient may not click an advertiser's hyperlink that is presented on a Web page, or may not otherwise opt-in to receive such advertisements.

Moreover, the nature of electronic media has rendered some methods for valuing advertisements ineffective. For example, location and circulation, which are the primary factors in pricing advertisements in print media, may be not be adequate to valuate electronic advertisements associated with an electronic magazine.

### SUMMARY OF THE INVENTION

Embodiments of the invention seek to overcome one or more of the disadvantages described above by leveraging electronic advertisements that were developed for use in one distribution channel in another distribution channel. In addition, embodiments of the invention better integrate an electronic advertisements into electronic content. Embodiments of the invention also provide alternative methods for valuing electronic advertisements that may be better suited to present and emerging distribution channels. As a consequence of features disclosed herein, electronic advertising can be more cost-effective for advertisers, a more available source of revenue for content providers, and/or more creatively priced than by known methods.

In accordance with one aspect, the present disclosure is directed toward a method for advertising in electronic media. The method includes receiving, in the electronic media development system, advertisement data associated with a first published media source and determining a target audience associated with the received advertisement data. Based on the target audience, a second published media source is selected. The method also includes receiving, in the electronic media development system, content data associated with the second published media source. Each of the advertisement data and the content data are arranged in a design environment associated with the electronic media development system, based on a predetermined format associated with the published media source. An interactive electronic media file for use on a web browser is generated. This interactive electronic media file includes a plurality of embedded features, each of the embedded features providing, when executed by a user, at least a portion of the advertisement data or the content data according to the predetermined format.

An embodiment of the invention provides a method for uploading the interactive electronic media file to a network server for distribution by a publisher associated with the second published media source. Additionally, the interactive electronic media file may be uploaded to one or more distribution modules associated with the publisher, wherein the one or more distribution modules provides an interface for downloading the interactive electronic media file. The interactive electronic media file may be downloaded by one or more subscribers of the second published media source.

An embodiment of the invention provides a method for determining a target audience associated with the advertisement data. The method includes analyzing a historical advertising metric associated with the first published media source. Historical advertising, as the term is used herein, may include, for example, user interaction data associated with a web advertisement, viewer ratings associated with a television advertisement, and/or data provided by survey participants in response to the advertisement data.

An embodiment of the invention provides a method for arranging the advertisement data and the content data within a design environment associated with the electronic media development system. The method includes enhancing one or more of the advertisement data or the content data for display, via the web browser, on a processor-based system. This processor-based system may include any type of processor-based, web-enabled system such as, for example, a computer system, a handheld communication device, a video game console, or a processor-based display device.

According to one embodiment, first and second published media sources described above may each embody one or more of print media, television media, or web media. For example, the first published media source may include television media, and the second published media source may include a magazine publication. The electronic media development system may receive a video commercial segment associated with a video telecast and receive one or more text segments corresponding to a content article associated with the magazine publication. The electronic media development system may generate the interactive electronic media file by embedding the video commercial segment within interactive electronic media file at a desired location associated with an electronic magazine publication corresponding to a print version of the magazine publication. Accordingly, the interactive electronic media file is adapted to provide the video commercial segment in response to a predetermined user action detected by the interactive electronic media file.

An embodiment of the invention provides a method for selecting an particular publication in which to provide an electronic advertisement campaign. The method includes analyzing circulation data associated with a plurality of published media sources and identifying demographic data corresponding to each of the published media sources based on the analysis. The demographic data associated with each of the published media sources may then be compared with demographic data associated with the target audience. Based on the demographic data comparison, one or more published media sources for providing particular advertisement data may be selected.

Embodiments of the invention also provide a processor-readable medium having stored thereon instructions for executing one or more of the aforementioned methods.

The invention will now be described with respect to exemplary embodiments illustrated in the drawings and discussed in the detailed description.

### BRIEF DESCRIPTION OF THE DRAWINGS

FIG. 1 is a flow diagram of an electronic publication process, according to an embodiment of the invention.

FIG. 2 is a flow diagram of an electronic publication process, according to an embodiment of the invention.

FIG. 3 is a flow diagram of an advertising process, according to an embodiment of the invention.

FIG. 4 is a flow diagram of a graphical user interface process, according to an embodiment of the invention.

FIG. 5 is an illustration of a table comparing valuation features, according to an embodiment of the invention.

FIG. 6A is a flow diagram of a valuation process, according to an embodiment of the invention.

FIG. 6B is a flow diagram of a valuation process, according to an embodiment of the invention.

FIG. 6C is a flow diagram of a valuation process, according to an embodiment of the invention.

### DETAILED DESCRIPTION

As used herein, content refers to media that primarily contains something of informational and/or entertainment value. For example, print content may be or include an article in a magazine or newspaper, and electronic content may be or include an article on a Web page, a movie in video stream format, or a musical recording contained in an audio file. As used herein, and advertisement refers to media that primarily contains a promotional message for goods and/or services.

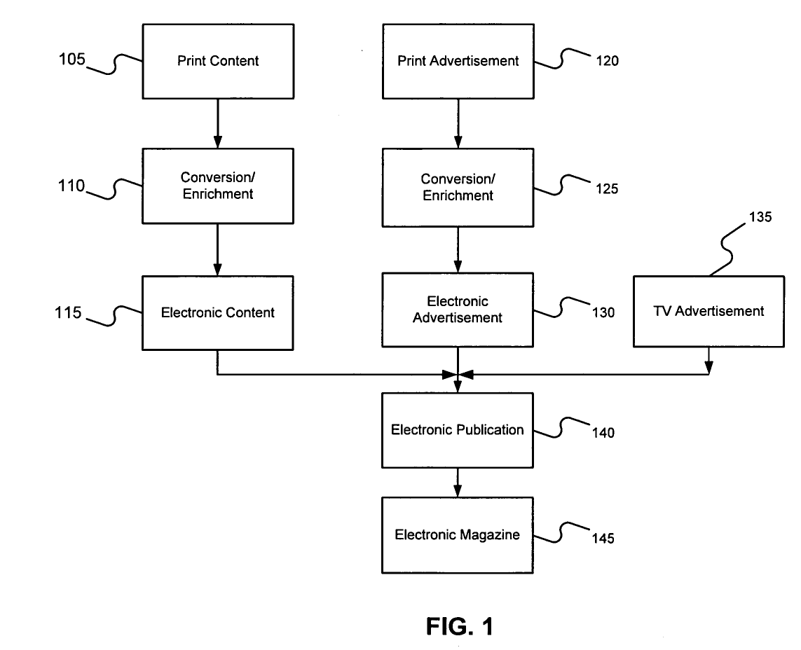

FIG. 1 is a flow diagram of an electronic publication process, according to an embodiment of the invention. As shown in FIG. 1, print content 105 may be input to conversion/enrichment process 110. The output of conversion/enrichment process 110 is electronic content 115. Print advertisement 120 may be input to conversion/enrichment process 125. The output of conversion/enrichment step 125 is an electronic advertisement 130. In step 140, the process may combine the electronic content 115, the electronic advertisement 130 and the TV advertisement 135 to output the electronic magazine 145.

For purposes of illustration, print content 105 could be or include one or more articles from a print version of a magazine, and print advertisement 120 could be or include a print advertisement. Conversion/enrichment steps 110 and 125 may convert print format into electronic format and may also enhance the original image, for example by adding color, audio, and/or user-interface features. A potential benefit of the process illustrated in FIG. 1 is that expenses associated with the development of print content 105, print advertisement 120, and/or TV advertisement 135 are leveraged to produce the electronic magazine 145. Such process may therefore provide more advertising revenue to the content provider and/or more advertising exposure for the advertiser.

Many variations to above process are possible. For example, electronic content 115 may have been created in electronic format in the first instance, in which case the print content 105 and conversion/enrichment step 110 may not be required. Likewise, electronic advertisement 130 may have been created in electronic format in the first instance, in which case the print advertisement 120 and conversion/enrichment step 125 may not be required. In addition, the utilization of electronic advertisement 130 that is separate from the TV advertisement 135 is optional. The use of TV advertisement 135 is optional. Moreover, graphical animation, electronic audio files, or other forms of electronic content and/or electronic advertisements not shown in FIG. 1 could be combined in publication step 140 to output the electronic magazine 145.

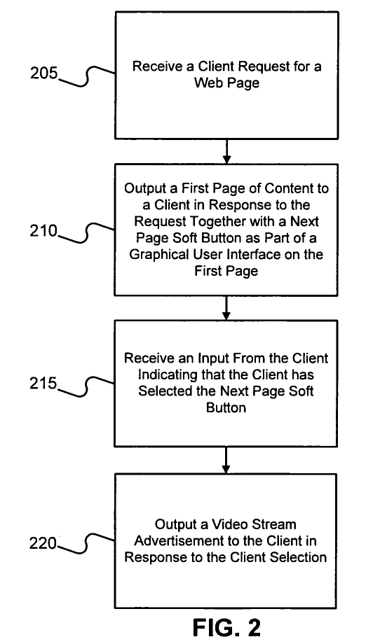

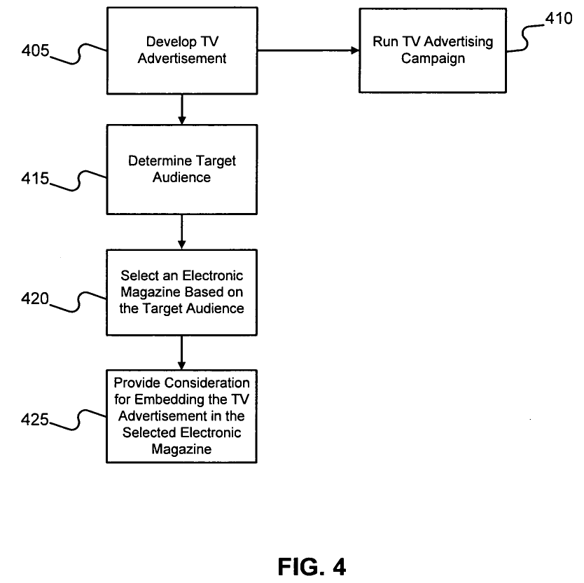

FIG. 2 is a flow diagram of an electronic publication process, according to an embodiment of the invention. The process is illustrated from the perspective of a publisher or other content provider. In step 205, the process develops print magazine content. Subsequently, the process may publish a print magazine in step 210 and determine a target audience based on the print magazine content in step 215. Then, the process advances to step 220 to sell advertising for an electronic magazine based on the target audience. The sale of advertising in step 220 relates to the receipt of compensation from an advertiser, or a promise of such compensation, in exchange for a promise by the content provider to distribute electronic advertisements together with electronic content. The advertiser could be a seller of goods or services, an agent of such seller, a non-profit entity, or a third party associated with such seller or non-profit entity. Next, in step 225, the process receives an electronic advertisement. The electronic advertisement received in step 225 could be, for instance, a video stream originally developed for TV distribution. Also subsequent to step 220, the process converts the print magazine content to electronic magazine content in step 230. Finally, in step 235, the process embeds the electronic advertisement into electronic magazine content. An embodiment for embedding the electronic advertisement into the magazine content is described with reference to FIG. 4 below.

A potential benefit of the process illustrated in FIG. 2 is that expenses associated with the development of print content in step 205 are leveraged in conversion step 230 to produce an electronic magazine. Traditionally, development step 205 and publication step 210 are funded by reader subscriptions, newsstand sales, and advertising revenue associated with publication of the print magazine. Because of the minimal costs associated with re-purposing the print magazine content in step 230, the electronic magazine may be fully funded by revenue generated in advertising sales step 220.

Variations to the process flow illustrated in FIG. 2 are possible. For example, the sequence of the illustrated steps may be changed: determining step 215 could precede development step 205, and conversion step 230 could precede sales step 220 or follow receipt step 225 according to design choice.

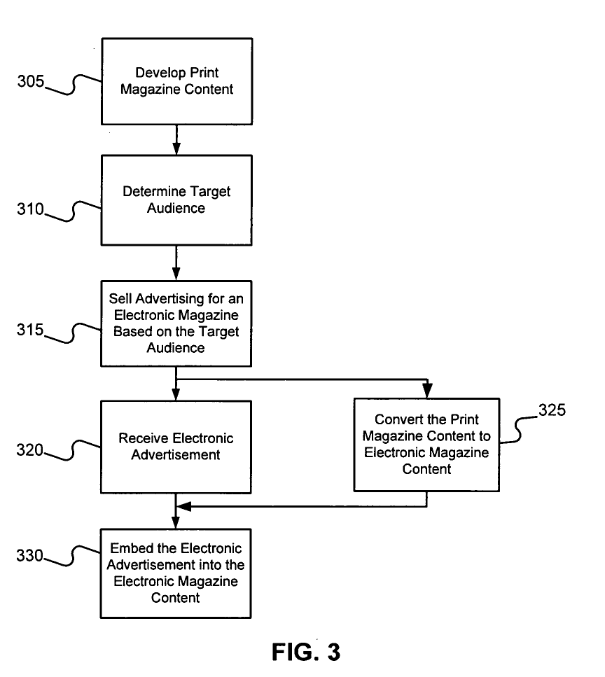

FIG. 3 is a flow diagram of an advertising process, according to an embodiment of the invention. FIG. 3 is illustrated from the perspective of an advertiser. The process begins by developing a TV advertisement in step 305. Next, in step 310, the process may run a TV advertising campaign. Also subsequent to step 305, the process advances to step 315 to determine a target audience for the TV advertisement. Then, in step 320, the process selects an electronic magazine based on the target audience. Finally, in step 325, the process provides consideration to a publisher for embedding the TV advertisement in the selected electronic magazine. As used with reference to step 325, the TV advertisement is a video stream advertisement originally developed for TV distribution.

A potential benefit of the process illustrated in FIG. 3 is that expenses associated with the development of the TV advertisement in step 305 may be leveraged by utilizing the TV advertisement in both a TV advertising campaign (step 310) and in an electronic magazine. Moreover, use of the TV advertisement in the electronic magazine may reach a relatively more narrow demographic target than in a TV advertising campaign, for example where the electronic magazine relates to a special interest topic and where the TV advertising campaign is associated with a program of general interest such as network TV news.

Variations to the process flow illustrated in FIG. 3 are possible. For example, the sequence of the illustrated steps may be changed: determining step 315 could precede development step 305.

FIG. 4 is a flow diagram of a graphical user interface process, according to an embodiment of the invention. The process in FIG. 4 is illustrated from the perspective of a host system. The host system could be or include a Web server in a wired or wireless client-server network architecture. The host system may include a processor, processor-readable memory, and processor-executable code stored on the processor-readable memory for performing the steps illustrated in FIG. 4. The client could be or include a personal computer, Web-enabled phone, personal digital assistant, media player, or similar device, and may also include Web browser software and/or other user-interface code. A client user is a person using the client to receive electronic content and/or electronic advertisements.

As shown in FIG. 4, the process begins in step 405 by receiving a client request for a Web page. Next, in step 410, the process outputs a first page of content to a client in response to the request, together with a next page soft button as part of a Graphical User Interface (GUI) on the first page. Then, in step 415, the process receives an input from the client indicating that the client has selected the next page soft button. Finally, in step 420, the process outputs a video stream advertisement to the client in response to the client selection.

Advantageously, a client user does not have to opt-in to receive the electronic advertisement. For instance, the client user is not required to click a hyperlink or otherwise select an electronic advertisement. In the illustrated embodiment, the electronic advertisement is not automatically launched upon a client user's initial request for a Web page. Instead, the electronic advertisement could be triggered by a request for a next page of the electronic magazine.

In an alternative embodiment of the invention, the host outputs a second page of electronic content in step 420 in response to a client user's first selection of the next page soft button in step 415, and outputs an electronic advertisement in response to a client user's second selection of the next page soft button. Other variations as to the frequency with which the host would respond to a next page request with an electronic advertisement are possible.

In yet other embodiments of the invention, which may be used in combination with, or in the alternative to, the next page soft button, other user interaction with the electronic content may trigger the delivery of an electronic advertisement. For example, the host may deliver an electronic advertisement if a client user clicks or otherwise selects a predetermined portion of the electronic content.

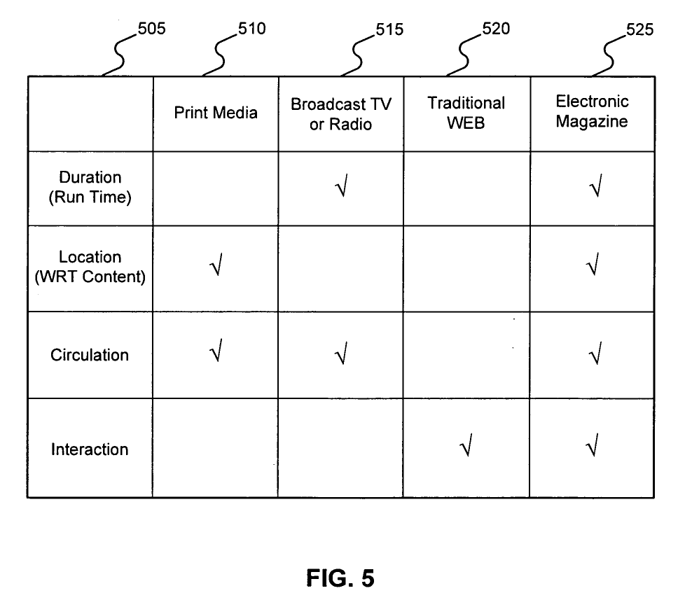

FIG. 5 is an illustration of a table comparing valuation features, according to an embodiment of the invention. As shown therein, features in column 505 may be compared with print media valuation as illustrated in column 510, broadcast TV or radio valuation as illustrated in column 515, traditional Web advertising valuation as illustrated in column 520, and electronic magazine advertising valuation as illustrated in column 525. The table in FIG. 5 illustrates that typical valuation for print media is based on location and circulation as illustrated in column 510. The valuation table illustrated in FIG. 5 indicates that broadcast TV or radio valuation is typically based on the duration and circulation of the broadcast media, as indicated in column 515. Traditional Web-based advertising valuations are based on user interaction, as indicated in column 520. In a departure from traditional print, broadcast, and Web-based valuations, electronic magazine advertising valuations may be based on one or more of duration, location, circulation, and/or interaction factors, as illustrated in column 525.

As used herein, duration (or run time) refers to the length of time an advertisement is run. In the case of broadcast radio or TV, duration may be a function of the length of the advertisement, the frequency that the advertisement airs, and the number of days, weeks, or months that the advertisement runs at the specified frequency. In the case of an electronic magazine, the duration may be, for instance, the number of days, weeks, or months that the advertisement is available for Web-based delivery from a host to a client user. As used herein, location refers to positioning of the advertisement with respect to electronic content. For example, for a print magazine, an advertisement placed on the inside cover might be valued higher than an advertisement placed on page 20. Location could have similar meaning for an electronic magazine. As used herein, circulation in the print media context refers to a number of subscribers and/or newsstand and other non-subscription retails sales. Such data may be determined by Audit Bureau of Circulations (ABC) surveys. In the case of broadcast media, the valuation factor analogous to circulation is market share. TV market share may be measured via Nielsen media household surveys, and radio market share may be measured via Arbitron Company surveys. As used herein, interaction refers to user interaction with the advertisement. For example, in conventional Web-based advertising, interaction (or effectiveness) may be expressed as impressions (e.g., Web page hits), interactive clicks, or actions (such as a registration, opt-in, or sale). Such interactions may be measured by BPA Worldwide Web Site Audits. Other interactive measures are also possible.

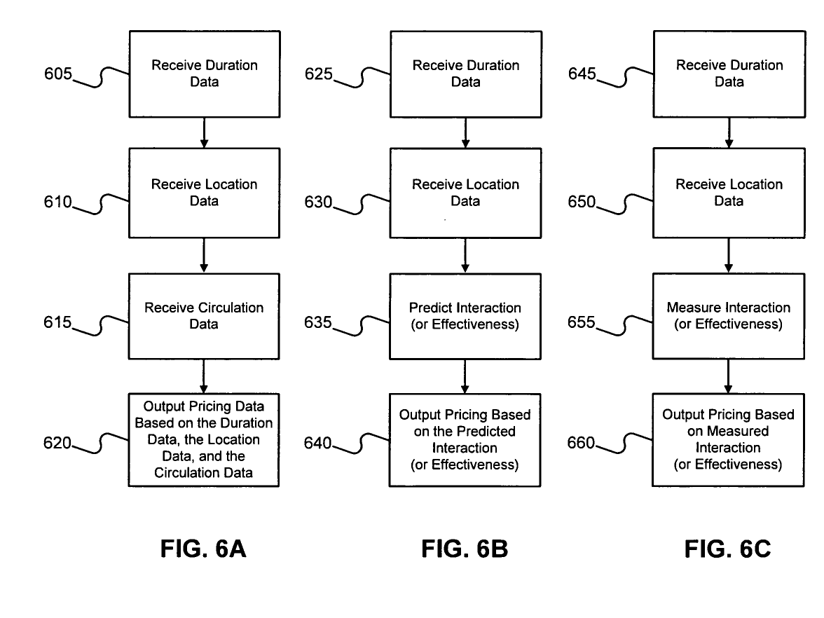

Alternative embodiments of electronic magazine valuation are described below with reference to FIGS. 6A, 6B, and 6C.

FIG. 6A is a flow diagram of a valuation process, according to an embodiment of the invention. As illustrated therein, the process begins in step 605 by receiving duration data. Next, in step 610, the process receives location data. Then, in step 615, the process receives circulation data. The circulation data in step 615 may be based, for example, on the measured circulation of the print magazine as a proxy for the number of people that will view the electronic magazine. Finally, in step 620, the process outputs pricing data based on the duration data, the location data, and the circulation data. FIG. 6A illustrates that electronic magazines may be valued as a hybrid of print and broadcast valuation methods.

FIG. 6B is a flow diagram of a valuation process, according to an embodiment of the invention. The process begins by receiving duration data in step 625. Next, in step 630, the process receives location data. Then, in step 635, the process predicts a level of user interaction (or effectiveness) based on the duration and location data. For example, step 635 may be informed by the historical measured interaction for similar advertisements having similar duration and location factors. Finally, in step 640, the process outputs pricing based on the predicted user interaction (or effectiveness).

FIG. 6C is a flow diagram of a valuation process, according to an embodiment of the invention. The process begins in step 645 by measuring user interaction (or effectiveness). Step 645 may be accomplished, for example, by measuring interaction (or effectiveness) associated with a trial run of the electronic advertisement together with the electronic content. In step 650, the process outputs pricing for a future duration based on measured user interaction (or effectiveness) during the trial run.

In an alternative embodiment of the process illustrated in FIG. 6C, there is no trial run, and step 645 is performed during the duration of the electronic advertising campaign. In this instance, valuation step 650 is performed subsequent to the electronic advertising campaign based solely on measured interaction (or effectiveness) during the electronic advertising campaign, and at least part of the compensation paid to the content provider would be deferred in this instance.

It will be apparent to those skilled in the art that various modifications and variations can be made to the disclosed systems and methods. For instance processes described herein may be used in combinations not explicitly described. Accordingly, other embodiments will be apparent to those skilled in the art from consideration of the specification and practice of the disclosed system and methods. It is intended that the specification and examples be considered as exemplary only, with a true scope being indicated by the following claims and their equivalents.

What is claimed is:

1. A method for advertising in electronic media comprising:
receiving, in the electronic media development system, advertisement data associated with a first published media source;
determining a target audience associated with the received advertisement data;
selecting a second published media source based on the target audience;
receiving, in the electronic media development system, content data associated with the second published media source;
arranging, in a design environment associated with the electronic media development system, each of the advertisement data and the content data based on a predetermined format associated with the first published media source; and
generating an interactive electronic media file for use on a web browser, wherein the interactive electronic media file includes a plurality of embedded features, each of the embedded features providing, when executed by a user, at least a portion of the advertisement data or the content data according to the predetermined format.

2. The method of claim 1, further including uploading the interactive electronic media file to a network server for distribution by a publisher associated with the second published media source.

3. The method of claim 2, wherein uploading the interactive electronic media file includes uploading the interactive electronic media file to one or more distribution modules associated with the publisher, wherein the one or more distribution modules provides an interface for downloading the interactive electronic media file.

4. The method of claim 3, further including providing, by the distribution module, the interactive electronic media file to a subscriber associated with the second published media source.

5. The method of claim 1, wherein determining a target audience associated with the advertisement data includes analyzing a historical advertising metric associated with the first published media source.

6. The method of claim 5, wherein the historical advertising metric includes user interaction data associated with a web advertisement.

7. The method of claim 5, wherein the historical advertising metric includes viewer ratings associated with a television advertisement.

8. The method of claim 5, wherein the historical advertising metric includes data provided by survey participants in response to the advertisement data.

9. The method of claim 1, wherein arranging the advertisement data and the content data includes enhancing one or more of the advertisement data or the content data for display, via the web browser, on a processor-based system.

10. The method of claim 9, wherein the processor-based system includes a computer system, a handheld communication device, a video game console, or a processor-based display device.

11. The method of claim 1, wherein the first and second published media source includes one or more of print media, television media, or web media.

12. The method of claim 1, wherein the first published media source includes television media, and receiving the advertisement data includes receiving a video commercial segment associated with a video telecast.

13. The method of claim 12, wherein the providing of the at least a portion of the advertisement data includes displaying the video commercial segment associated with the video telecast.

14. The method of claim 12, wherein the second published media source includes a magazine publication, and receiving the content data includes receiving one or more text segments corresponding to a content article associated with the magazine publication.

15. The method of claim 14, wherein the predetermined format includes an electronic magazine template wherein the interactive electronic media file includes an interactive magazine publication comprising:
a plurality of electronic pages, each electronic page corresponding to a particular page associated with a print publication; and
a plurality of user-selectable soft keys that, when selected by a user, manipulates a portion of the interactive magazine publication in a predetermined manner.

16. The method of claim 1, wherein generating the interactive electronic media file includes embedding the advertisement data within interactive electronic media file at a desired location associated with the second published media source, wherein the interactive electronic media file is adapted to provide the advertisement data in response to a predetermined user action detected by the interactive electronic media file.

17. The method of claim 16, wherein the soft-keys include one or more of a bookmark soft key, a next page soft key, a previous page soft key, a soft key linking a particular electronic page, or a soft key linking a table of contents associated with the interactive magazine publication.

18. The method of claim 1, wherein the advertisement data includes one or more of a television advertisement, a web advertisement, or a print advertisement.

19. The method of claim 1, wherein the advertisement data includes an advertising budget.

20. The method of claim 1, wherein selecting the second published media source includes:
analyzing circulation data associated with a plurality of published media sources;
identifying demographic data corresponding to each of the published media sources based on the analysis;
comparing the demographic data associated with each of the published media sources with demographic data associated with the target audience; and
selecting the second published media source based on the demographic data comparison, wherein the second published media source is selected as the published media source with demographic data that most closely corresponds to the demographic data associated with the target audience.

21. A computer-readable medium for use on a computer system, the computer readable-medium having computer-executable instructions for performing the method of claim 1.
